(19) United States
(12) Patent Application Publication
(10) Pub. No.: US 2004/0061083 A1
(43) Pub. Date: Apr. 1, 2004

(54) Trouble-free flush valve

(76) Inventor: Hong-Ming Cheng, Taipei (TW)

Correspondence Address: Hong-Ming Cheng, P. O. Box 55-846, Taipei, 104, TW

(21) Appl. No.: 10/351,778

(22) Filed: Jan. 24, 2003

(30) Foreign Application Priority Data
Sep. 30, 2002 (TW) 91215685

(51) Int. Cl. F16K 31/12

(52) U.S. Cl. 251/30.01

(57) ABSTRACT

A flush valve includes: a valve body; a diaphragm valve flexibly mounted in the valve body; a central partition plate secured in the valve body having a valve seat annularly formed in the central partition plate to be seated by the diaphragm valve for closing an outlet port of the diaphragm valve; a valve flap held on the diaphragm valve having at least one rubbing pin formed on the valve flap for reciprocatively rubbing or purging any scales or dirts accumulated in the releasing hole or capillary hole formed through the diaphragm valve for preventing clogging of the releasing hole; a manual relief valve and an electrically operated relief valve respectively formed on the valve body.

### BACKGROUND OF THE INVENTION

This application is an improvement of U.S. Pat. No. 6,000,674 (hereinafter called as “prior art”) issued to the same inventor of this application. The prior art disclosed a reliable flush valve for manually or automatically discharging water for flush purpose.

However, the prior art has the following drawbacks:

1. The releasing hole (or capillary hole) 231 as provided in the upper disk 23 of the diaphragm valve 2 has a very small diameter (which is generally ranging from 0.4˜0.6 mm) and can be easily blockaded by scale, dirts or sludge laden in the water stream to influence an automatic closing of the flush valve, thereby deteriorating its normal flush effect.

2. The manual relief valve 5 requires a large volume (space) for accommodating many elements of the relief valve. Meanwhile, it requires a high-pressure water supply, such as being greater than 20 pounds per square inch (psi), in order to actuate the relief valve. If the pressure of water supply is less than 20 psi, the restoring or resetting speed of the piston 531 (as thrusted by the weak water pressure) may be slower than the resetting speed of the tension spring 532 when closing the valve, thereby influencing a normal working of the relief valve 5. Even the tension spring 532 may be replaced with spring of reduced resilience, the valve plug 51 will then be restored very slowly, thereby delaying the closing of the valve or even possibly causing incomplete closing of the relief valve 5 to cause continuous flush of water for wasting water resource.

The present inventor has found the drawbacks of the prior art and invented the present flush valve for overcoming the troubles as caused in the prior art.

### SUMMARY OF THE INVENTION

The object of the present invention is to provide a flush valve including: a valve body; a diaphragm valve flexibly mounted in the valve body; a central partition plate secured in the valve body having a valve seat annularly formed in the central partition plate to be seated by the diaphragm valve for closing an outlet port of the diaphragm valve; a valve flap held on the diaphragm valve having at least one rubbing pin formed on the valve flap for reciprocatively rubbing or purging any scales or dirts accumulated in the releasing hole or capillary hole formed through the diaphragm valve for preventing clogging of the releasing hole; a manual relief valve and an electrically operated relief valve respectively formed on the valve body; with the manual relief valve formed with a forcible driving mechanism including operating elements having a compact volume.

### BRIEF DESCRIPTION OF THE DRAWINGS

FIG. 1 is an exploded view showing the elements of the present invention.

FIG. 2 is a partially enlarged view of the diaphragm valve and the valve flap of the present invention.

FIG. 3 is an exploded view of the manual relief valve of the present invention.

FIG. 4 is a partial sectional drawing of the present invention as assembled and when closed.

FIG. 5 is a sectional drawing of the present invention when closed.

FIG. 6 is a partial sectional drawing of the present invention when opened.

FIG. 7 is an illustration of the present invention when opened, as partially enlarged from FIG. 6.

FIG. 8 is a sectional drawing of the present invention when opened.

FIG. 9 is a sectional drawing of a modified embodiment of the present inventions equivalent to that as shown in FIG. 6.

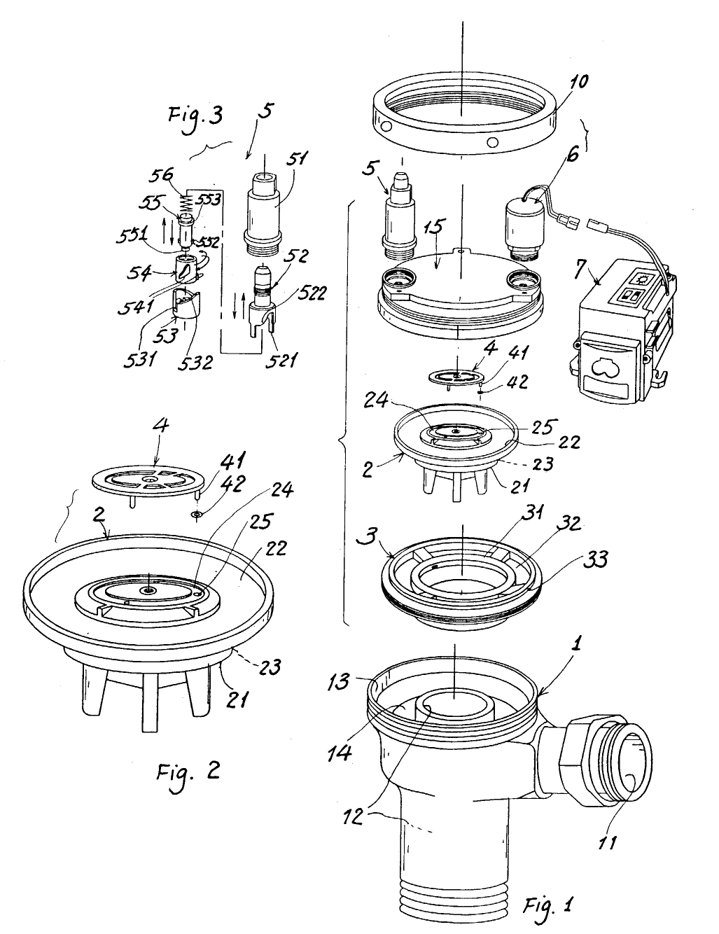

### DETAILED DESCRIPTION

As shown in FIGS. 1˜8, the trouble-free flush valve of the present invention comprises: a valve body 1; a diaphragm valve 2 flexibly mounted in the valve body 1; a central partition plate 3 secured in the valve body 1 for separating an upstream and a downstream water streamflow; a valve flap 4 held on the diaphragm valve 2 for reducing water pressure of the incoming water supply; a manual relief valve 5 mounted on the valve body 1 for manually opening the valve for flushing water; and an electrically operated relief valve 6 mounted on the valve body 1 juxtapositioned or opposite to the manual relief valve 5 for flushing water and having a controller 7 mounted on the valve body 1 for controlling the electrically operated relief valve 6.

The present invention may be proved for flushing any plumbing systems, including toilets, urinals and faucets, manually or automatically.

The valve body 1 includes: an inlet pipe 11 for entering incoming water (I), an outlet pipe 12 for discharging or delivering water outwardly or downwardly (O), an outer barrel 13 circumferentially disposed about the outlet pipe 12 and defining an annular port 14 between the outer barrel 13 and the outlet pipe 12, an upper cover 15 encased on an upper portion of the valve body 1 and coupled with the outer barrel 13 by a fastening member 10, an upper chamber 151 defined between the upper cover 15 and the diaphragm valve 2 which is normally seated on the central partition plate 3 secured on the outlet pipe 12 and on the outer barrel 13, and an annular discharge conduit 16 fluidically communicated with the upper chamber 151 as controlled by the manual relief valve 5 and the electrically operated relief valve 6 for discharging water outwardly or downwardly through the annular port 14 and the outlet pipe 12 when either relief valve 5 or 6 is opened.

The diaphragm valve 2 includes: a disk-shaped plug 21 normally rested on a valve seat 31 formed on the central partition plate 3, a diaphragm member 22 radially disposed about the disk-shaped plug 21 and flexibly retained between the upper cover 15 and the central partition plate 3, a water conduit 23 internally formed through the diaphragm valve 2 to be fluidially communicated with the annular port 14 as communicated with the inlet pipe 11 through a plurality of slots 32 arcuately formed in an annular portion of the central partition plate 3, a retaining disk 24 formed on an upper portion of the diaphragm valve 2 for retaining the diaphragm member 22 on the valve 2 and also for engaging or holding the valve flap 4 with the retaining disk 24, and a plurality of releasing holes 25 formed through the retaining disk 24 and fluidically communicated with the water conduit 23 internally formed in the diaphragm valve 2. A filter F may be provided in the valve 2 for filtering off any dirts laden in the water stream.

The releasing holes 25 may also be directly formed in other portions of the diaphragm valve 2 between the inlet pipe 11 and the upper chamber 151 as partitioned by the diaphragm member 22 for reducing water pressure from the incoming water stream (I).

The valve flap 4 includes: a plurality of rubbing pins (or at least a rubbing pin) 41 perpendicularly protruding downwardly from the flap 4 which may be formed as a circular disk or annular ring, having the rubbing pin 41 jacketed with a packing ring 42 thereon and each rubbing pin 41 reciprocatively engageable with each releasing hole 25 formed in the diaphragm valve 2 for rubbing, purging and removing any scale, dirts or sludge accumulated in the releasing hole 25 for preventing from clogging of the releasing hole 25.

The rubbing pin 41 has a diameter smaller than an inside diameter of the inside wall of each releasing hole 25, namely, the aperture (A) between the rubbing pin 41 and the inside wall of the releasing hole 25 having an appreciable annular aperture to thereby allow an easy removal of any scales or dirts accumulated in such an aperture (A) when purged by water streamflow passing through such an aperture and thereby reliably “rubbing” the releasing hole 25 for removing the scales or dirts to prevent from the clogging thereof. Meanwhile, such an annular aperture between the pin 41 and the wall of the releasing hole 25 will prevent from a direct frictional rubbing or wearing by the pin 41 on the inside wall of the releasing hole 25 for protecting the hole 25.

The valve flap 4 has, the rubbing pin 41 jacketed with the packing ring 42 on the pin 41, whereby upon normal resting of the flap 4 on the diaphragm valve 2, the packing ring 42 will be snugly engaged in the annular aperture (A) between the pin 41 and the releasing hole 25. If the water pressure becomes high, the water streamflow may slightly lift the flexible periphery of the flap 4 and disengage the packing ring 42 from the releasing hole 25 to increase the flow speed of the flush water to shorten the water-flushing time of the flush valve. However, when the water pressure becomes low, the water-flow speed will be slow down to slightly defer the water-flushing time. Therefore, the valve flap 4 with its rubbing pin 41 may also help maintain a homogeneous water flush by keeping a generally constant water-flushing volume through the flush valve. The valve flap 4 may be coaxially secured to the diaphragm valve 2 as axially formed in the pipe 12 about the axis X.

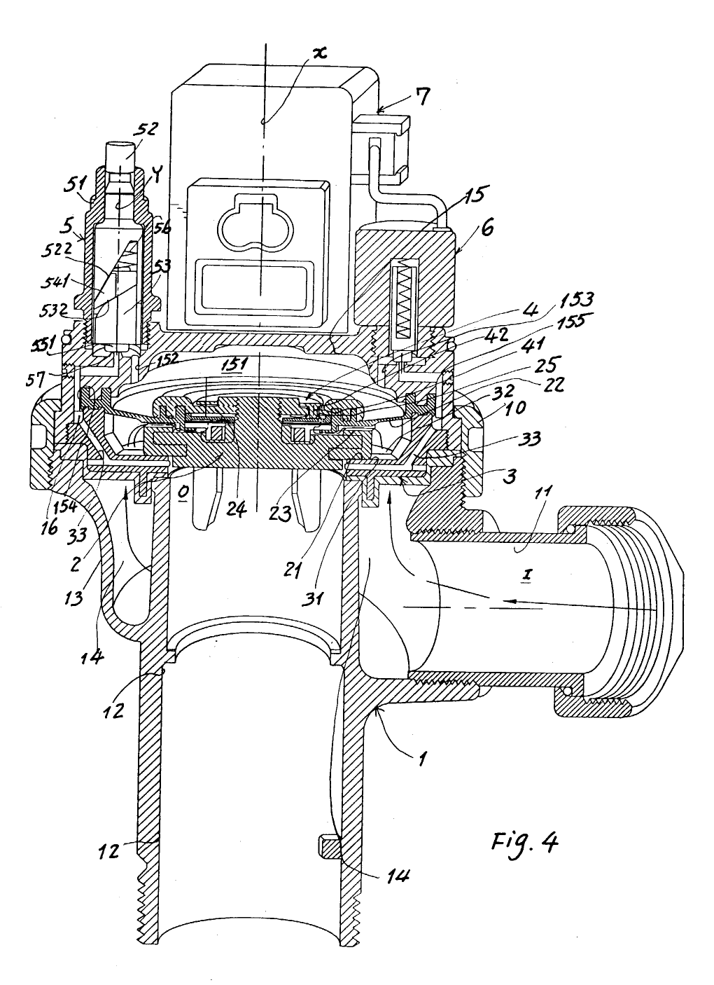

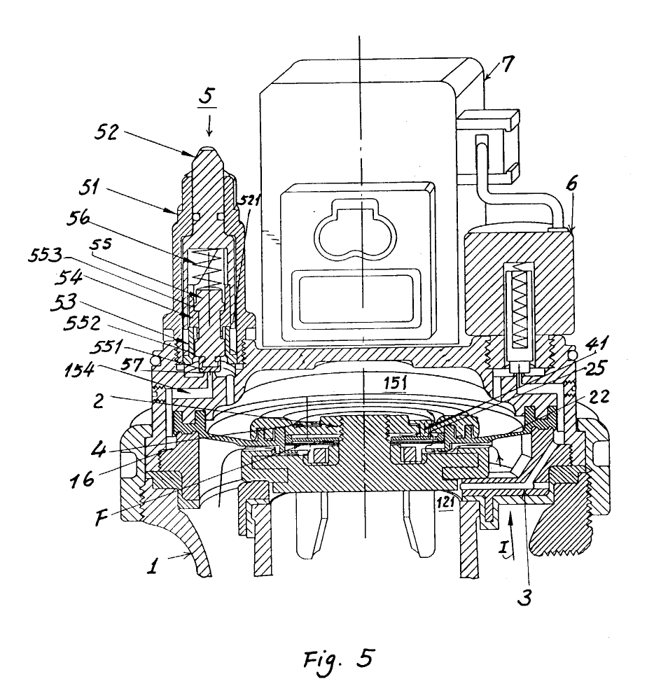

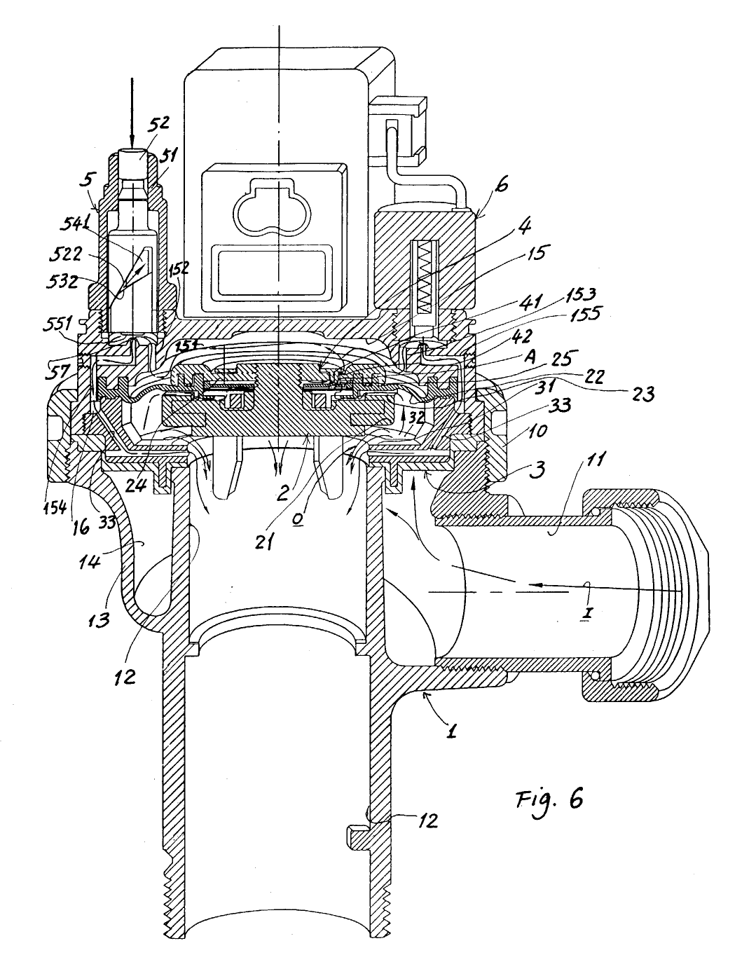

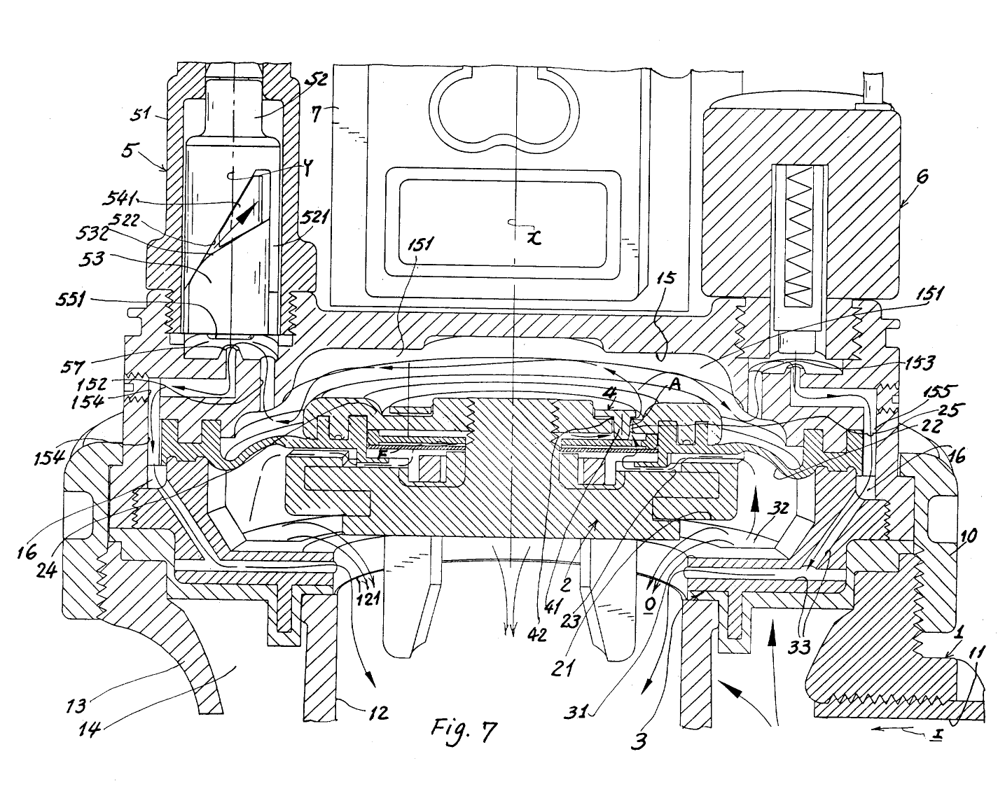

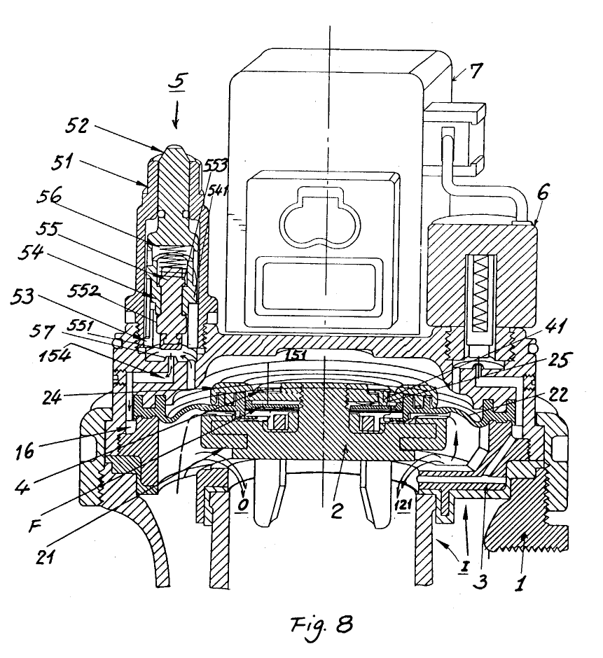

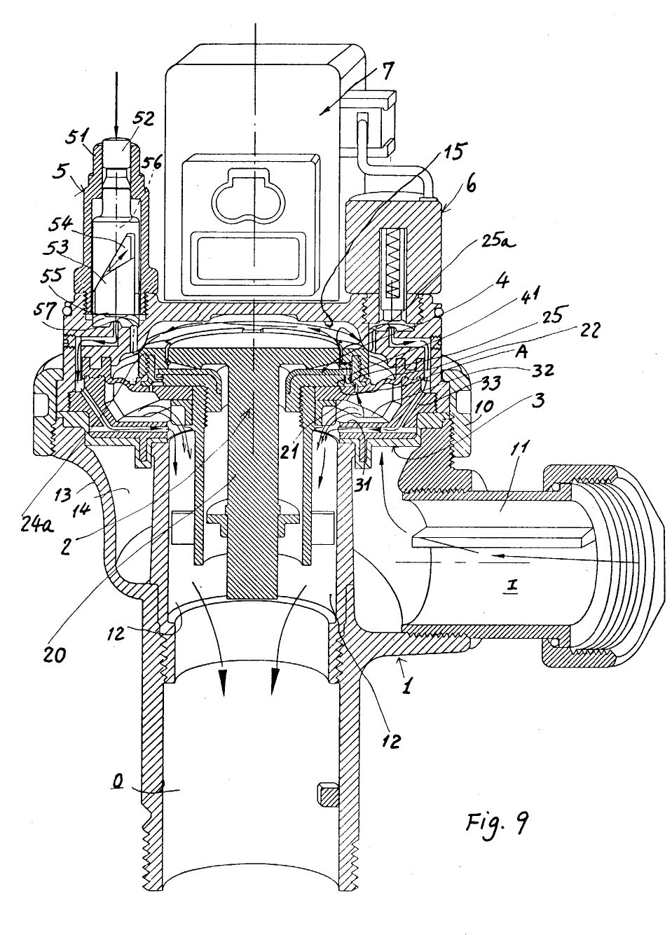

When opening either valve (5 or 6) of the present invention for flushing purpose from FIG. 4 (or FIG. 5) to FIG. 6 (or FIGS. 7 and 8), the water in the upper chamber 151 will be discharged, through the discharge conduits 152, 154 formed at the manual relief valve 5 or through the conduits 153, 155 formed at the electrically operated relief valve 6, into the annular port 14 to reduce the pressure in the upper chamber 151; and the incoming water with higher pressure will urge the diaphragm member 22 upwardly to open the disk-shaped plug 21 of the diaphragm valve 2 to thereby open the discharge (outlet) port between the plug 21 and the seat 31 of the partition plate 3; whereby the downward water streamflow will be discharged through the discharge holes 33 formed in the partition plate 3 and finally discharged (O) through the outlet port at the outlet pipe 12.

After closing the valves 5, 6 and “re-filling” of incoming water in the upper chamber 151 by the incoming water supply, the diaphragm member 22 will be restored downwardly to re-close the plug 21 on the seat 31 (FIGS. 4, 5).

When the flap 4 is restored to be rested on the retaining disk 24, the packing ring 42 will be engaged with the releasing hole 25.

Upon the opening or closing of the diaphragm valve 2 to simultaneously actuate the valve flap 4 upwardly or downwardly, each rubbing pin 41 on the flap 4 will serve as a cleaning rubbing member to rub, purge, or remove any scale, dirts or sludge accumulated in each releasing hole 25 formed in the diaphragm valve 2 to prevent from clogging of the releasing holes 25 to maintain a smooth reliable operation of the present invention.

The manual relief valve 5 of the present invention includes: a housing 51 secured on the upper cover 15 of the flush valve, a push-button actuator 52 reciprocatively held in the housing 51 and having at least a bottom sloping-surface portion 522 spirally formed on a cylindrical bottom portion of the actuator 52, a lower thrusting member 53 formed in a bottom of the housing 51 having at least a top sloping-surface portion 532 spirally formed on a top portion of the lower thrusting member 53 as cylindrically shaped, a rotor 54 having at least a sloping-surface extension 541 circumferentially spirally formed on a cylindrical wall of the rotor 54 to be engageably spaced in between the bottom sloping-surface portion 522 of the actuator 52 and the top sloping-surface portion 532 of the thrusting member 53, a stem 55 engaged with the rotor 54 having a plug portion 551 formed on a bottom of the stem 55, a restoring spring 56 tensioned between the actuator 52 and the stem 55, and a plug seat 57 formed on an inlet port of a discharge conduit 154 fluidically communicated with the outlet pipe 12; with the plug portion 551 normally rested on the plug seat 57 as restored by the restoring spring 56 when closing the manual relief valve 5; whereby upon a downward depression of the push-button actuator 52 to allow the sloping-surface portion 522 of the actuator 52 and the sloping-surface portion 532 of the thrusting member 53 to squeeze and upwardly thrust the sloping-surface extension 541 of the rotor 54 for rotating and raising the rotor, the stem 55 as engaged with the rotor 54 will be cooperatively raised by the rotor 54 to lift and open the plug portion 551 for opening the manual relief valve 5. All elements of the manual relief valve 5 are inter-related and limited within the housing 51 having a cylindrical bore formed in the housing.

Since the plug portion 551 of the stem 55 is raised to open the relief valve 5 by a forcible depression (driving) of the push-button actuator 52, the valve 5 can be opened very smoothly. After releasing the push-button actuator 52, the restoring spring 56 will restore to drive the stem 55 and rotor 54 downwardly to allow the plug portion 551 to re-close the plug seat 57 to close the relief valve 5 accordingly.

The actuator 52, the thrusting member 53, the rotor 54 and the stem 55 are mutually engageable in a “cylindrical configuration”, not a lengthy or elongate structure as disclosed in the prior art, thereby saving their volume and making the relief valve in a very compact form.

The manual relief valve 5 is operated in a forcible driving way, regardless of the water pressure flowing through the flush valve. Even the incoming water has a low water pressure, it will not influence the opening or closing of the manual relief valve 5. The resilience of restoring spring 56 is well designed to be larger than the water pressure as normally working, and upon releasing of the push-button actuator 52 for closing an opened relief valve 5, the spring 56 will undoubtedly restore to re-close the plug portion 551 on the plug seat 57. So, the present invention can be operated smoothly without any trouble.

The push-button actuator 52 includes a plurality of guiding rods 521 protruding downwardly from the actuator to be parallel to a valve axis Y defined at a longitudinal center of the actuator 52 and the housing 51, each guiding rod 521 slidably and reciprocatively engageable with a guiding slot 531 formed in the lower thrusting member 53 parallel to the valve axis Y, thereby allowing a reliable reciprocative movement of the actuator 52 in a vertical way in the housing.

The valve flap 4 may be secured on the valve 2 and upwardly limited by any stopping or fastening device.

As shown in FIG. 9, the present invention may be modified to provide the valve flap 4 within the diaphragm valve 2 having the rubbing pins 41 operatively rubbing and cleaning the releasing holes 25 formed in the diaphragm valve. The major differences include: an upper disk 24a (having water hole 25a formed therein to be communicated with the releasing hole 25) further provided to limit the valve flap 4 and a central stem 20 protruded downwardly from the valve 2 to be inserted into the outlet pipe 12.

The present invention may be further modified without departing from the spirit and scope of the present invention.

I claim:

1. A flush valve comprising:
a valve body having an inlet pipe and an outlet pipe;
a diaphragm valve flexibly mounted in the valve body in between said inlet pipe and said outlet pipe, and said diaphragm valve normally seated on a valve seat in the valve body for normally closing an outlet port on the outlet pipe of the flush valve; and
having a valve flap held on the diaphragm valve; and
a manual relief valve formed on the valve body for manually opening the flush valve;
said valve flap including: at least one rubbing pin protruding downwardly from the flap, said rubbing pin jacketed with a packing ring thereon and said rubbing pin reciprocatively moving within a releasing hole formed in the diaphragm valve for rubbing, purging and removing scale accumulated in the releasing hole for preventing from clogging of the releasing hole.

2. A flush valve according to claim 1, wherein said valve flap is formed as a shape selected from a circular disk and an annular ring coaxially held on said diaphragm valve, said rubbing pin perpendicularly protruding downwardly from said valve flap.

3. A flush valve according to claim 1, wherein said valve flap is resiliently held on said diaphragm valve as upwardly limited by a retaining disk secured on an upper portion of said diaphragm valve.

4. A flush valve according to claim 1, wherein said valve seat for normally resting said diaphragm valve thereon is formed on a central partition plate secured in said valve body for directing a water streamflow from said inlet pipe through said central partition plate and said diaphragm valve towards said outlet pipe of said valve body.

5. A flush valve according to claim 1, wherein said manual relief valve includes: a housing secured on the valve body, a push-button actuator reciprocatively held in the housing and having at least a bottom sloping-surface portion spirally formed on a cylindrical bottom portion of the actuator, a lower thrusting member formed in a bottom of the housing having at least a top sloping-surface portion spirally formed on a top portion of the lower thrusting member as cylindrically shaped, a rotor having at least a sloping-surface extension circumferentially spirally formed on a cylindrical wall of the rotor to be engageably spaced in between the bottom sloping-surface portion of the actuator and the top sloping-surface portion of the thrusting member, a stem engaged with the rotor having a plug portion formed on a bottom of the stem, a restoring spring tensioned between the actuator and the stem, and a plug seat formed on an inlet port of a discharge conduit fluidically communicated with the outlet pipe; with the plug portion normally rested on the plug seat as restored by the restoring spring when closing the manual relief valve; whereby upon a downward depression of the push-button actuator to allow the sloping-surface portion of the actuator and the other sloping-surface portion of the thrusting member to squeeze and upwardly thrust the sloping-surface extension of the rotor for rotating and raising the rotor, the stem as engaged with the rotor will be cooperatively raised by the rotor to lift and open the plug portion for opening the manual relief valve.

6. A flush valve comprising: a valve body having an inlet and an outlet pipe; a diaphragm valve positioned in between said inlet pipe and said outlet pipe and flexibly mounted on said valve body and normally rested on a valve seat in said valve body for closing an outlet port on said outlet pipe; and a manual relief valve including: a housing secured on the valve body, a push-button actuator reciprocatively held in the housing having at least a bottom sloping-surface portion spirally formed on a cylindrical bottom portion of the actuator, a lower thrusting member formed in a bottom of the housing having at least a top sloping-surface portion spirally formed on a top portion of the lower thrusting member as cylindrically shaped, a rotor having at least a sloping-surface extension circumferentially spirally formed on a cylindrical wall of the rotor to be engageably spaced in between the bottom sloping-surface portion of the actuator and the top sloping-surface portion of the thrusting member, a stem engaged with the rotor having a plug portion formed on a bottom of the stem, a restoring spring tensioned between the actuator and the stem, and a plug seat formed on an inlet port of a discharge conduit fluidically communicated with the outlet pipe; with the plug portion normally rested on the plug seat as restored by the restoring spring when closing the manual relief valve; whereby upon a downward depression of the push-button actuator to allow the sloping-surface portion of the actuator and the other sloping-surface portion of the thrusting member to squeeze and upwardly thrust the sloping-surface extension of the rotor for rotating and raising the rotor, the stem as engaged with the rotor will be cooperatively raised by the rotor to lift and open the plug portion for opening the manual relief valve.
